(19) United States
(12) Patent Application Publication
(10) Pub. No.: US 2005/0199444 A1
(43) Pub. Date: Sep. 15, 2005

(54) JMAC system

(76) Inventors: Juan R. Pineiro, Reading, PA (US); Timothy W. McDonald, Reading, PA (US)

Correspondence Address: Timothy W. McDonald, 191 Wanner Rd., Reading, PA, 19606, US

(21) Appl. No.: 10/797,309

(22) Filed: Mar. 11, 2004

(51) Int. Cl. F16C 3/14

(52) U.S. Cl. 184/1.5

(57) ABSTRACT

Unique feature of the JMAC system: The container that the oil is purchased in is the container the JMAC system pumps from to provide oil to an engine. Specially designed universal caps that are part of the JMAC system do this. This makes the system convenient for customer, because there is no mess and the oil container is easy to replace. Some of the benefits of the JMAC system: 1.) The JMAC system can provide engine protection while transportation is in motion. There is no need to stop on the roadside or in route if oil is needed. 2.) Clean, convenient and safe. Reduces the risk of getting burned by coming into contact with a hot engine. 3.) Environmentally friendly, oil will remain in a self-contained state. Which means less oil spillage.

### CROSS - REFERENCE TO RELATED APPLICATION

Give priority to Provisional Patent:

Application Number: # 60/416,455

Date Oct. 31, 2002

(JMAC) System

Filing Receipt: # *OC000000009042510

Confirmation NO. 4947

### STATEMENT REGARDING FEDERALLYSPONSORED RESEARCH OR DEVELOPMENT

NOT APPLICABLE

### REFERENCE TO SEQUENCE LISTING, A TABLE, OR A COMPACT PROGRAM LISTING COMPACT DISC APPENDIX NOT APPLICABLE

### BACKGROUND OF THE INVENTION

Principle of this invention is to provide a backup oil supply for any engine in the event an engine should run low on oil. The JMAC system helps to prevent engine damage and costly repairs due to running an engine while it is low on oil or without oil.

The JMAC system can add oil safely, cleanly, without the use of a funnel and while an engine is running or transportation is in motion.

Primary areas of interest for this invention would be aviation, automotive, military or anything that relies on oil to lubricate an engine.

Some of the unique features the JMAC system consist of is the container that the oil is purchased in, is the container the JMAC system adapts to and pumps from to provide oil to an engine. Specially designed universal caps that are part of the JMAC system do this. What this means is no mess and easy to replace. In one word (convenient)! The JMAC system connects directly to the top of the purchased oil container, which is placed in a holder bracket. When the container is empty it is discarded properly and replaced with a new oil container. The universal caps remain attached to the JMAC system and equipment.

### BRIEF SUMMARY OF THE INVENTION

The general idea of the (JMAC) system is to provide backup/reserve oil supply for any engine in the event an engine should run low on oil.

Some advantages of the (JMAC) system;

1.) Can provide engine protection while transportation is in motion. There is no need to stop on the roadside to add oil if your engine gets low on oil.

2.) Clean, convenient safe. Reduces the risk of getting burned by coming into contact with a hot engine.

3.) Environmentally friendly, oil will no longer be poured out of a container and spilled onto the ground Or hot engine. Until the JMAC system, oil was left to burn off an engine releasing air toxins.

Problems the (JMAC) system solves.

a.) Can prevent a roadside breakdown

b.) Can save on major repairs

c.) Can protect engines from damage

d.) Can save on warranty cost

### BRIEF DESCRIPTION OF PICTURES

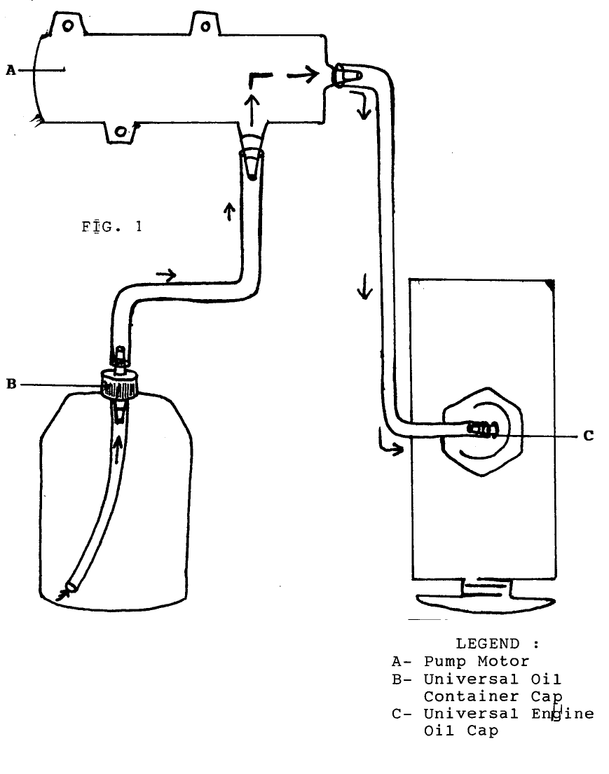

FIG. 1

Picture (1)

JMAC systems universal engine oil cap

Picture (2)

JMAC systems universal oil container cap

Picture (3)

Manual on/off illuminated toggle switch for (JMAC) system

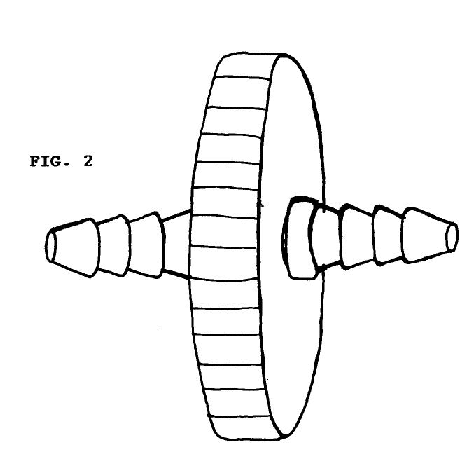

FIG. 2
a.) Universal oil container cap
b.) Universal engine oil cap
c.) JMAC system pump
d.) (Ze'sal) style oil container holder
e.) Manual on /off illuminated toggle switch

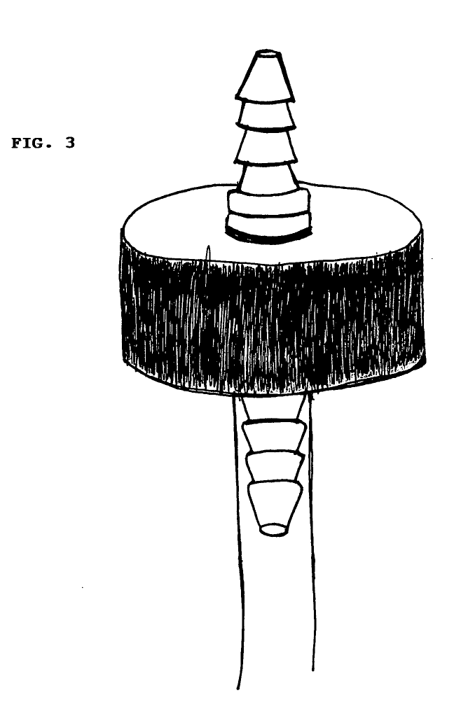

FIG. 3
Picture (1) Complete (JMAC) system kit
JMAC system installation instruction sheet & content list

FIG. 4
a.) Sketch of the JMAC system invention Drawing (1)
b. (Bag) style oil container holder Drawing Fig. (1) & (2)
c.) Electric automatic feed system Drawing Fig. (3)

### DETAILED DESCRIPTION OF THE INVENTION

### WHAT THE JMAC SYSTEM DOES:

1.) Provides a backup oil reserve for any engine that runs low on oil.
2.) Adds oil safely, cleanly and conveniently
3.) Self service in a self service time

### HOW THE JMAC SYSTEM WORKS:

First, the JMAC system is mounted in a convenient place and is activated by a switch, either manually or electronically on the instr ment panel.

Secondly, Oil is pumped from the container it is purchased in by removing the container cap and putting the JMAC system universal oil container cap on.

Third, The lubricant travels through the JMAC system and into the universal engine oil cap located on the engine.

### HOW TO MAKE AND INSTALL THE JMAC SYSTEM

Please refer to the (Brief Description of Pictures) FIG. 3, JMAC system installation instructions.

1. We claim that the JMAC system is the first to use a universal cap and the container that the oil, fluid or solvent comes in, as a backup reservoir to be pumped from.

2. We also claim to be the first to use a universal engine oil cap to pump oil through into the top of an engine.

3. As well we claim the bag style holder for the container to be a first of its kind.
In conclusion, the jmac system was created as a customer friendly backup oil supply system, in the event an engine's oil supply would become dangerously low in or at an inconvenient time or place:
